(19) United States
(12) Patent Application Publication
(10) Pub. No.: US 2017/0099383 A1
(43) Pub. Date: Apr. 6, 2017

(54) METHOD AND SYSTEM FOR MEDIATING USES OF SMART DEVICES OF GROUP USERS BY UTILIZING LOCATION-BASED VIRTUAL SELF-CONTROL SPACE

(71) Applicant: Korea Advanced Institute of Science and Technology, Daejeon (KR)

(72) Inventors: Uichin LEE, Daejeon (KR); Minsam KO, Daejeon (KR); Seungwoo Choi, Daejeon (KR)

(73) Assignee: Korea Advanced Institute of Science and Technology, Daehak-ro (KR)

(21) Appl. No.: 15/284,240

(22) Filed: Oct. 3, 2016

(30) Foreign Application Priority Data
Oct. 5, 2015 (KR) 10-2015-0139547

(51) Int. Cl. H04M 1/725; H04W 4/02

(52) U.S. Cl. CPC H04M 1/72577; H04W 4/021; H04M 1/72569; H04M 1/72572

(57) ABSTRACT

A method for mediating uses of smart devices of group users includes creating a location-based virtual self-control space, searching for a virtual self-control space that is adjacent to a smart device of a requester for mediating uses of the smart devices of the group users, from the created virtual self-control space, selecting an interest space which the requester is to participate in, from the found virtual self-control space, and allowing smart devices of group users pertaining to the interest space to participate in self-control of use, allowing the smart devices of the group users to apply a use restraining mode in the virtual self-control space corresponding to the interest space, and after applying the use restraining mode, allowing the smart devices of the group users to release the use restraining mode in the virtual self-control space corresponding to the interest space.

### CROSS-REFERENCE TO RELATED APPLICATIONS

A claim for priority under 35 U.S.C. §119 is made to Korean Patent Application No. 10-2015-0139547 filed Oct. 5, 2015, in the Korean Intellectual Property Office, the entire contents of which are hereby incorporated by reference.

### BACKGROUND

Embodiments of the inventive concept described herein relate to a method and a system for mediating uses of smart devices of group users by utilizing a location-based virtual self-control space.

The inventive concept relates to a method and a system for reducing disturbances of the user due to excessive use of a smart device. Due to the development of the mobile technologies, including the smartphones, the number of accesses to the smart device systems for the purpose of acquisition of information, social communications, and entertainments has recently been increasing.

However, due to the excessive use of smart devices, the individual activities have been frequently disturbed and the disturbance of the group activities (for example, classes, group discussions, and group studies) has become a serious social problem. The individuals have to spontaneously self-control use of smartphones, but it is not easy practically due to the characteristics of the smart devices.

The smartphones are mediums that may be easily accessed because they are carried by individuals. Because the advantages of the personal portable terminals are integrated with the mobile phones so that access to the internet and a data communication function are supported, various media may be easily accessed. Further, messages may be transmitted and received in real time between long-distance users by using the smartphones.

Restricting use of mobile devices for protection of group activities is a considerably interested subject, and a representative method thereof is compulsorily interrupting use of a smartphone (for example, jamming of wireless signals or location-based interruption).

However, interrupting use of the smart devices without explicit agreement of the users violates the current rules (for example, an act of disturbing other's communications or an act of disturbing transmission and reception of signals), and cannot be practically applied.

Accordingly, the concept of a location based virtual self-control space by which a plurality of persons at a specific location may commonly and spontaneously self-control use (for example, only reception of a call is allowed) of the smartphones is necessary. The method may arbitrarily define a form of a virtual self-control space at a desired location (for example, setting of a name, an expiration time, and restriction of use), and a plurality of virtual self-control spaces may exist at one site.

A new interactive technology of allowing the user to spontaneously search for a virtual self-control space and select a self-control space in which self-control is commonly made, unlike the conventional compulsory method is necessary.

### SUMMARY

Embodiments of the inventive concept provide a method and a system for effectively reducing disturbance of a group activity due to use of a smart device

In accordance with an aspect of the inventive concept, there is provided a method for mediating uses of smart devices of group users, the method including creating a location-based virtual self-control space, searching for a virtual self-control space that is adjacent to a smart device of a requester for mediating uses of the smart devices of the group users, from the created virtual self-control space, selecting an interest space which the requester is to participate in, from the found virtual self-control space, and allowing smart devices of group users pertaining to the interest space to participate in self-control of use, allowing the smart devices of the group users to apply a use restraining mode in the virtual self-control space corresponding to the interest space, and after applying the use restraining mode, allowing the smart devices of the group users to release the use restraining mode in the virtual self-control space corresponding to the interest space.

The creating of the location-based virtual self-control space may include collecting location information of the requester for medicating uses of the smart devices of the group users, setting the virtual self-control space, based on the collected location information, and registering the preset virtual self-control space in a database.

The setting of the virtual self-control space may be changed and the changed virtual self-control space may be reregistered, and the setting of the virtual self-control space may include space information and self-control restraining rules for respective self-control spaces.

Functions of the self-control restraining rules include a function of temporarily releasing a restraint.

The searching for the virtual self-control space includes collecting information of a location at which the requester is currently situated, and searching for the location information of the requester and a virtual self-control space that is situated within a preset range.

The selecting of the interest space includes collecting the location information of the requester, selecting an interest space, which the requester is to participate in, of the found virtual self-control space, and allowing the smart devices of the group users pertaining to the interest space to participate in a group self-control mode through participation in the virtual self-control space.

The allowing of the smart devices of the group users to apply a use restraining mode in the virtual self-control space may include, at the same time when the use restraining mode starts, periodically recording a group situation of the smart devices of the group users and peripheral devices connected to the smart devices, and restricting a specific function of functions of the smart devices of the group users and the peripheral devices connected to the smart devices.

In accordance with another aspect of the inventive concept, there is provided a system for mediating uses of smart devices of group users, the system including a virtual self-control space creating unit that creates a location-based virtual self-control space, a virtual self-control space searching unit that searches for a virtual self-control space that is adjacent to a smart device of a requester for mediating uses of the smart devices of the group users, from the created virtual self-control space, an execution unit that selects an interest space which the requester is to participate in, from the found virtual self-control space, and allows smart devices of group users pertaining to the interest space to participate in self-control of use, and a control unit that allows the smart devices of the group users to apply or release a use restraining mode in the virtual self-control space corresponding to the interest space.

The virtual self-control space creating unit may collect location information of the requester for medicating uses of the smart devices of the group users, may set the virtual self-control space, based on the collected location information, and may register the preset virtual self-control space in a database.

The virtual self-control space searching unit may collect information of a location at which the requester is currently situated, and may search for the location information of the requester and a virtual self-control space that is situated within a preset range.

The execution unit may collect the location information of the requester, selects an interest space, which the requester is to participate in, of the found virtual self-control space, and may allow the smart devices of the group users pertaining to the interest space to participate in a group self-control mode through participation in the virtual self-control space.

At the same time when the use restraining mode starts, the control unit may periodically record a group situation of the smart devices of the group users, and may restrict a specific function of functions of the smart devices of the group users.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a flowchart illustrating a method for mediating uses of smart devices of group users according to an embodiment of the inventive concept;

FIG. 2 is an example illustrating a screen for creating a new location-based virtual self-control space according to an embodiment of the inventive concept;

FIG. 3 is an example illustrating a screen for searching or and participating in a virtual self-control space according to an embodiment of the inventive concept; and

FIG. 4 is a view illustrating a configuration of a system for mediating uses of smart devices of group users according to an embodiment of the inventive concept.

### DETAILED DESCRIPTION

Hereinafter, exemplary embodiments of the inventive concept will be described in detail with reference to the accompanying drawings.

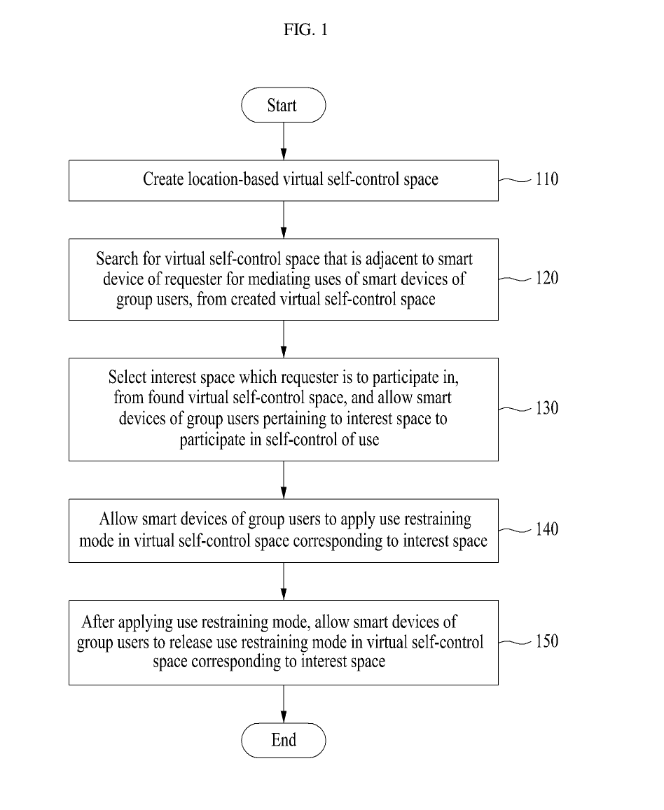

FIG. 1 is a flowchart illustrating a method for mediating uses of smart devices of group users according to an embodiment of the inventive concept.

In the proposed method for mediating uses of smart devices of group users by utilizing a location-based virtual self-control space, the user defines a virtual self-control space at a specific location. Thereafter, a virtual self-control space that is located within a preset range is searched for by collecting location information of a requester. Further, the users undergo an operation of selecting an interest space from the found virtual self-control space and participating in a self-control. A use restraining mode is applied to the smartphones of the users in the virtual self-control space, and the users undergo an operation of releasing the use restraining mode if the personal activities end. The method of mediating uses of smart devices of group users will be described in more detail with reference to FIG. 1.

The method for mediating uses of smart devices of group users includes an operation 110 of creating a location-based virtual self-control space, an operation 120 of searching for a virtual self-control space that is adjacent to a smart device of a requester for mediating uses of the smart devices of the group users, from the created virtual self-control space, an operation 130 of selecting an interest space in which the requester is to participate, from the found virtual self-control space, and allowing smart devices of group users pertaining to the interest space to participate in self-control of use, an operation 140 of allowing the smart devices of the group users to apply a use restraining mode in the virtual self-control space corresponding to the interest space, and an operation 150 of, after applying the use restraining mode, allowing the smart devices of the group users to release the use restraining mode in the virtual self-control space corresponding to the interest space.

In operation 110, one or more location-based virtual self-control spaces may be created at a specific location. In other words, the location-based virtual self-control spaces are defined at a specific location.

Operation 110 may include an operation of collecting location information of the requester for mediating uses of the smart devices of the group users, an operation of setting the virtual self-control space, based on the collected location information, and an operation of registering the preset virtual self-control space in a database. The proposed method may recognize a location of a user and may define a virtual self-control space by using the recognized location. At least one virtual self-control space is allowed at a specific location.

The setting of the virtual self-control space may be changed and the changed virtual self-control space may be reregistered, and the setting of the virtual self-control space includes space information and self-control restraining rules for respective self-control spaces.

That is, the user may designate or change the setting of the virtual self-control space. The setting of the virtual self-control space, for example, includes information on a room and a self-control restraining rule.

The information on the room may include various pieces of information. For example, the information may include a room name, a virtual room activity, a room number (automatically designated by a system), and a room form (closed, open, an ending time, information on a location at which the user is to open a virtual self-control space, and the like).

Further, various self-control restraining rule may be included in the self-control restraining rule that may be set. For example, the self-control restraining rule may include a time that is to be restricted, a time (release allowable time) at which restraints for individuals may be temporarily released, a specific smartphone function (vibration, an alarm, a sound, or the like) that will not be restricted, a specific smartphone app (a letter, communication, an internet browser, playback of music, an SNS service, or the like) that will not be restricted. In addition, the self-control restraining rule may include restraints of use (a specific function and a specific app) of peripheral devices (for example, a smartwatch and a sliding caliper) connected to a smart device.

Further, the self-control restraining rule that may be set may include a method of temporarily releasing restraints. That is, a selectively allowable method may be applied.

For example, while the smart phones of the members are controlled, the user may release a control state for a preset time period. The release allowable time of the user is displayed during a release state such that the user may identify it (for example, displayed at an upper end of a screen). Further, if the release allowable time ends, the smart device automatically enters a control state again. Through the function, the user may flexibly deal with the situation even when the user abruptly needs to use the smartphone in the middle of a restraint situation.

The space information and the self-control restraining rule may be individually set for the respective virtual self-control spaces. The inventive concept creates at least one virtual self-control space, in which uses of smart devices may be self-controlled for a specific physical place, and in particular, several different virtual self-control spaces having space information and/or self-control restraining rules for one physical place may be created by setting the space information and the self-control restraining rules to the respective virtual self-control spaces. Accordingly, the user may selectively reflect a virtual self-control space of an environment and a condition preferred by the user to use it. Accordingly, when several users are in the same place at the same time, different configurations and intensities of self-control of uses may be applied according to the virtual self-control spaces used by the users.

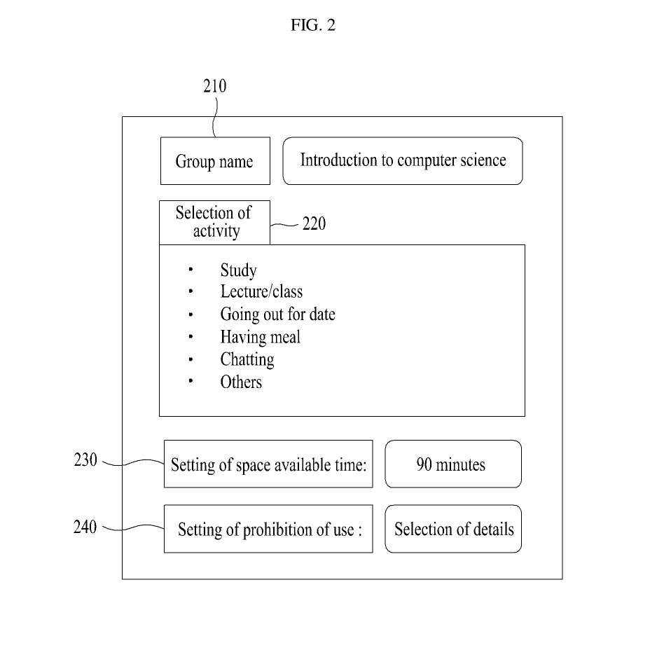

A screen for creating a new location-based virtual self-control space will be described in more detail with reference to FIG. 2.

FIG. 2 is an example illustrating a screen for creating a new location-based virtual self-control space according to an embodiment of the inventive concept.

As illustrated in FIG. 2, a group name 210 may be displayed in a screen for creating a new location-based virtual self-control space. Location information of a requester for mediating uses of smart devices of group users may be collected. For example, in the screen for creating the new location-based virtual self-control space, the group name 210 is assumed as introduction to computer science. Based on the collected location information, the virtual self-control space may be set and the set virtual self-control space may be registered in a database. The virtual self-control space may be defined in this way, and one or more virtual self-control spaces are possible at a lecture room of introduction to computer science.

The setting of the virtual self-control space may be changed and the changed virtual self-control space may be reregistered, and the setting of the virtual self-control space includes space information and self-control restraining rules for respective self-control spaces.

That is, the user may designate or change the setting of the virtual self-control space. The setting of the virtual self-control space, for example, includes information on a room and a self-control restraining rule.

The setting of the virtual self-control space may include selection 220 of an activity, setting 230 of a space available time, and setting 240 of prohibition of use.

For example, the selection 220 of an activity may include contents such as study, lecture/class, going out for a date, having a meal, chatting, and the like. The setting 230 of a space available time may be set to 90 minutes, and the setting 240 of prohibition of use may be set more specifically by pressing a detailed selection item.

Further, the self-control restraining rule that may be set may include a method of temporarily releasing restraints. That is, a selectively allowable method may be applied.

For example, while the smart phones of the members are controlled, the user may release a control state for a preset time period. The release allowable time of the user is displayed such that the user may identify it (for example, displayed at an upper end of a screen). Further, if the release allowable time ends, the smart device automatically enters a control state again. Through the function, the user may flexibly deal with the situation even when the user abruptly needs to use the smartphone in the middle of a restraint situation.

Referring back to FIG. 1, in operation 120, a virtual self-control space, which is adjacent to the smart device of the requester for mediating uses of the smart devices of the group users, of the created virtual self-control space may be searched for.

Information on a location at which the requester is currently situated may be collected, and the location information of the requester and a virtual self-control space that is situated within a preset range may be searched for.

As a representative method for searching for a virtual self-control space, a technology of detecting a short distance based on site information may use a location information collecting method (GPS) and a wireless fingerprint method (Wi-Fi search or the like).

In the location information collecting method (GPS), absolute coordinates may be collected.

In the wireless network fingerprint method, information on an access point (AP) of a cellular network or a Wi-Fi network or wireless Beacon (a Bluetooth low energy technology) may be collected (because the AP or Beacon is situated at a fixed site, relative location information exists).

When the absolute coordinates are compared with each other and the difference is within a preset threshold range, a GPS utilizing method may be used for searching for a close virtual self-control space.

Further, the wireless network fingerprint utilizing method may be used. A set of wireless network fingerprints collected when the virtual self-control space is created is indicated by A. Further, if the user requests a search, a set of wireless network fingerprints collected at the time of the request is indicated by B Further, the similarity of the two sets A and B is measured (for example, a Jacquard similarity measuring method or the like). When the measured similarity value is within a preset threshold value, a close virtual self-control space may be determined.

Further, if the system detects one or more group users who are situated within a short range, it may send a recommendation message to the user to urge a mediation activity of the system.

In operation 130, an interest space, which the requester is to participate in, of the found virtual self-control space may be selected, and the smart devices of the group users pertaining to the interest space may participate in the self-control of use.

The location information of the requester may be collected, an interest space, which the requester is to participate in, of the found virtual self-control space, may be selected, and the smart devices of the group users pertaining to the interest space may participate in a group self-control mode through participation in the virtual self-control space.

An interest space may be selected from the found virtual self-control space so that the smart devices participate in the self-control, and then the users automatically detect a virtual self-control space that is present within a short distance, based on the recorded information. Thereafter, a list of the virtual self-control spaces within a short distance is revealed so that a use restraining operation may be easily entered. Through this, the users may enter a use restraining mode.

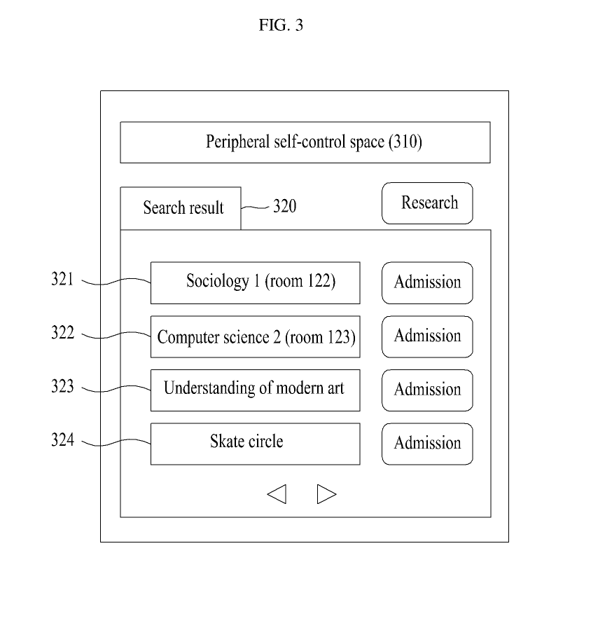

FIG. 3 is an example illustrating a screen for searching or and participating in a virtual self-control space according to an embodiment of the inventive concept.

The found peripheral self-control space 310 may be displayed on a screen for searching for and participating in a virtual self-control space. For example, sociology theory 1 (room 1122) 321, computer science 2 (room 123) 322, understanding of modern art 323, and skate circle 323 may be displayed in the search result 320 of the found peripheral self-control space 310. Further, an interest space, which the requester is to participate in, may be selected by pressing “Admission”, and the smart devices of the group users pertaining to the interest space may participate in the self-control of use.

In operation 140, the smart devices of the group users may apply a use restraining mode in the virtual self-control space corresponding to the interest space.

At the same time when the use restraining mode starts, a group situation of the smart devices of the group users may be periodically recorded, and a specific function of the functions of the smart devices of the group users may be restricted.

The users may start the use restraining modes of the smartphones of all the members according to a restraint rule set in the virtual self-control space. At the same time when the use restraining mode starts, the group situation of the users is periodically recorded.

The information that will be recorded may include various pieces of information. For example, the information may include smartphone information, network information, restraint release trail information, individual restraint times, times at which the individual restraints are temporarily released.

The use restraining mode refers to a state in which the functions of the smartphones of the users in participation are restricted, and include at least one of the following functions. For example, the use restraining mode includes at least one of stop of an alarm service, restraint of execution of an app, an alarm, and those (for example, receiving a phone call) that allow exceptional settings of uses of apps.

Further, the restraint by a preset restraint rule, of the use restraining mode, may be temporarily released.

Further, in order to motivate participation of the users in the virtual self-control space, points may be provided (for example, in proportion to the self-control time period) or points may be discriminatorily provided according to the characteristics of the locations. For example, a student who has frequently gone to a library and performed a self-control may collect points, and if the points correspond to a specific value or more, the student may be provided with a gift so that continuous participation may be induced.

In operation 150, after the use restraining mode is applied, the smart devices of the group users may release the use retraining mode in the virtual self-control space corresponding to the interest space.

If a preset restraint ending condition is satisfied, the use restraint mode may be released. The restraint ending condition may include the following functions. For example, the restraint ending condition may include functions such as ending of a preset in-use time, arrival of a preset ending time, request of a user.

Further, while the smartphone is restricted, the user may arbitrarily release a restraint.

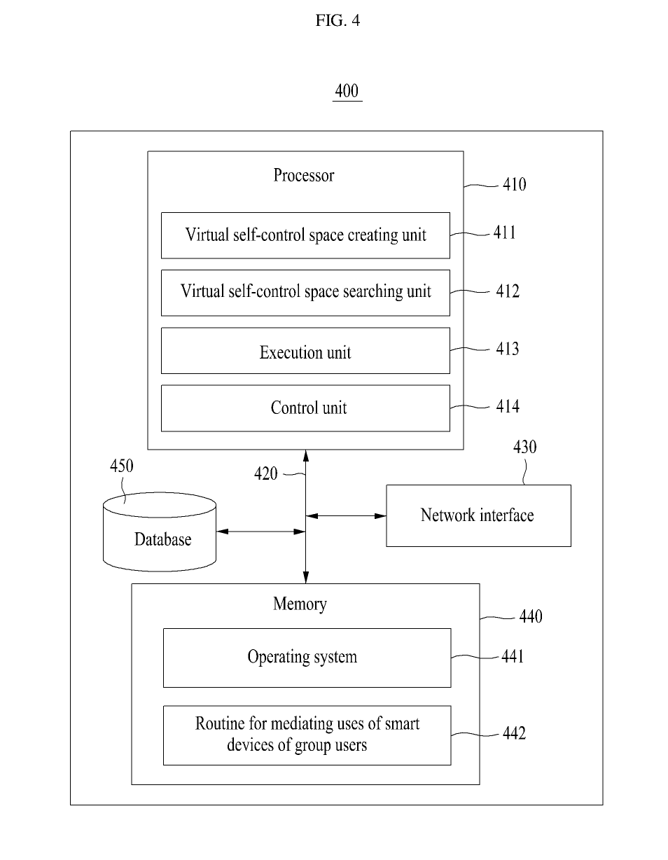

FIG. 4 is a view illustrating a configuration of a system for mediating uses of smart devices of group users according to an embodiment of the inventive concept.

The system 400 for mediating uses of smart devices of group users according to the embodiment may include a processor 410, a bus 420, a network interface 430, a memory 440, and a database 450. The memory 440 may include an operation system 441 and a routine 442 for mediating uses of smart devices of group users. The processor 410 may include an index creating unit 411, a prime number creating unit 412, and an execution unit 413. In another embodiment, the system 400 for mediating uses of smart devices of group users may include elements, the number of which is larger than that of the elements of FIG. 4. However, it is not necessary to clearly illustrate most of the conventional elements. For example, the system 400 for mediating uses of smart devices of group users may include another element such as a display or a transceiver.

The memory 440 is a computer readable recording medium, and may include a random access memory (RAM), a read only memory (ROM), and a permanent mass storage device such as a disk drive. Further, a program code for the operation system 441 and the routine 442 for mediating uses of smart devices of group users may be stored in the memory 440. The software elements may be loaded from a computer readable recording medium separately from the memory 440, by using a drive mechanism (not illustrated). The separate computer readable recording medium may include a computer readable recording medium (not illustrated), such as a floppy drive, a disk, a tape, a DVD/CD-ROM drive, or a memory card. In another embodiment, the software elements may be loaded in the memory 440 through a network interface 430 instead of a computer readable recording medium.

The bus 420 is responsible for communication and transmission of data between the elements of the system 400 for mediating uses of smart devices of group users. The bus 420 may be constituted by using a high-speed serial bus, a parallel bus, a storage area network (SAN), and/or another suitable communication technology.

The network interface 430 may be a computer hardware element for connecting the system 400 for mediating uses of smart devices of group users to a computer network. The network interface 430 may connect the system 400 for mediating uses of smart devices of group users to a computer network through a wired or wireless connection.

The database 450 may function to store and maintain all information that is necessary for mediating uses of the smart device of the group users. Although FIG. 4 illustrates that the database 450 is constituted in the system 400 for mediating uses of smart device of group users, the inventive concept is not limited thereto, and the database 450 may be omitted according to a system implementation scheme or an environment or a whole database or a portion of the database also may be present as an external database constructed in a separate another system.

The processor 410 may be configured to process a command of a computer program by performing a basic calculation, logic, and input/output operations of the system 400 for mediating uses of smart devices of group users. The command may be provided to the processor 410 by the memory 440 or the network interface 430, and through the bus 420. The processor 410 may be configured to execute a program code for the virtual self-control space creating unit 411, the virtual self-control space searching unit 412, the execution unit 413, and the control unit 414. The program code may be stored in a recording device such as the memory 440.

The index virtual self-control space creating unit 411, the virtual self-control space searching unit 412, the execution unit 413, and the control unit 414 may be configured to execute the operations 110 to 150 of FIG. 1.

The system 400 for mediating uses of smart devices of group users may include the index virtual self-control space creating unit 411, the virtual self-control space searching unit 412, the execution unit 413, and the control unit 414.

The virtual self-control space creating unit 411 creates a location-based virtual self-control space. The virtual self-control space creating unit 411 collects location information of a requester for mediating uses of smart devices of group users, sets the virtual self-control space, based on the collected location information, and registers the preset virtual self-control space in the database.

The system may recognize a location of a user and may define a virtual self-control space by using the recognized location. At least one virtual self-control space is allowed at a specific location.

The setting of the virtual self-control space may be changed and the changed virtual self-control space may be reregistered, and the setting of the virtual self-control space includes space information and self-control restraining rules for respective self-control spaces.

That is, the user may designate or change the setting of the virtual self-control space. The setting of the virtual self-control space, for example, includes information on a room and a self-control restraining rule.

The information on the room may include various pieces of information. For example, the information may include a room name, a virtual room activity, a room number (automatically designated by a system), and a room form (closed, open, an ending time, information on a location at which the user is to open a virtual self-control space, and the like).

Further, various self-control restraining rule may be included in the self-control restraining rule that may be set. For example, the self-control restraining rule may include a time that is to be restricted, a time (release allowable time) at which restraints for individuals may be temporarily released, a specific smartphone function (vibration, an alarm, or the like) that will not be restricted, a specific smartphone app (a letter, communication, an internet browser, playback of music, an SNS service, or the like) that will not be restricted. In addition, the self-control restraining rule may include restraints of use (a specific function and a specific app) of peripheral devices (for example, a smart watch and a sliding caliper) connected to a smart device.

Further, the self-control restraining rule that may be set may include a method of temporarily releasing restraints. That is, a selectively allowable method may be applied.

For example, while the smart phones of the members are controlled, the user may release a control state for a preset time period. The release allowable time of the user is displayed such that the user may identify it (for example, displayed at an upper end of a screen). Further, if the release allowable time ends, the smart device automatically enters a control state again. Through the function, the user may flexibly deal with the situation even when the user abruptly needs to use the smartphone in the middle of a restraint situation.

A virtual self-control searching unit 412 searches for a virtual self-control space that is adjacent to a smart device of a requester for mediating uses of the smart devices of the group users, from the created virtual self-control space. The virtual self-control space searching unit 412 collects Information on a location at which the requester is currently situated, and searches for the location information of the requester and a virtual self-control space that is situated within a preset range.

As a representative method for searching for a virtual self-control space, a technology of detecting a short distance based on place information may use a location information collecting method (GPS) and a wireless fingerprint method (Wi-Fi search or the like).

In the location information collecting method (GPS), absolute coordinates may be collected.

In the wireless network fingerprint method, information on an access point (AP) of a cellular network or a Wi-Fi network or wireless Beacon (a Bluetooth low energy technology) may be collected (because the AP or Beacon is situated at a fixed site, relative location information exists).

When the absolute coordinates are compared with each other and the difference is within a preset threshold range, a GPS utilizing method may be used for searching for a close virtual self-control space.

Further, the wireless network fingerprint utilizing method may be used. A set of wireless network fingerprints collected when the virtual self-control space is created is indicated by A. Further, if the user requests a search, a set of wireless network fingerprints collected at the time of the request is indicated by B. Further, the similarity of the two sets A and B is measured (for example, a Jacquard similarity measuring method or the like). When the measured similarity value is within a preset threshold value, a close virtual self-control space may be determined.

Further, if the system detects one or more group users who are situated within a short range, it may send a recommendation message to the user to urge a mediation activity of the system.

The execution unit 413 selects an interest space which the requester is to participate in, from the found virtual self-control space, and allows smart devices of group users pertaining to the interest space to participate in self-control of use. The execution unit 413 may collect the location information of the requester, selects an interest space, which the requester is to participate in, of the found virtual self-control space, and allows the smart devices of the group users pertaining to the interest space to participate in a group self-control mode through participation in the virtual self-control space.

An interest space may be selected from the found virtual self-control space so that the smart devices participate in the self-control, and then the users automatically detect a virtual self-control space that is present within a short distance, based on the recorded information. Thereafter, a list of the virtual self-control spaces within a short distance is revealed so that a use restraining operation may be easily entered. Through this, the users may enter a use restraining mode.

The control unit 414 allows the smart devices of the group users to apply or release a use restraining mode in the virtual self-control space. At the same time when the use restraining mode starts, the control unit 414 periodically records a group situation of the smart devices of the group users, and may restrict a specific function of the functions of the smart devices of the group users.

The users may start the use restraining modes of the smartphones of all the members according to a restraint rule set in the virtual self-control space. At the same time when the use restraining mode starts, the group situation of the users is periodically recorded.

The information that will be recorded may include various pieces of information. For example, the information may include smartphone information, network information, restraint release trail information, individual restraint times, times at which the individual restraints are temporarily released.

The use restraining mode refers to a state in which the functions of the smartphones of the users in participation are restricted, and includes at least one of the following functions. For example, the use restraining mode includes at least one of stop of an alarm service, restraint of execution of an app, an alarm, and those (for example, receiving a phone call) that allow exceptional settings of uses of apps.

Further, the restraint by a preset restraint rule, of the use restraining mode, may be temporarily released.

Further, in order to motivate participation of the users in the virtual self-control space, points may be provided (for example, in proportion to the self-control time period) or points may be discriminatorily provided according to the characteristics of the locations. For example, a student who has frequently gone to a library and performed self-control may collect points, and if the points correspond to a specific value or more, the student may be provided with a gift so that continuous participation may be induced.

Further, if a preset restraint ending condition is satisfied, the use restraint mode may be released. The restraint ending condition may include the following functions. For example, the restraint ending condition may include functions such as ending of a preset in-use time, arrival of a preset ending time, request of a user.

Further, while the smartphone is restricted, the user may arbitrarily release a restraint.

The foregoing devices may be realized by hardware elements, software elements and/or combinations thereof. For example, the devices and components illustrated in the exemplary embodiments of the inventive concept may be implemented in one or more general-use computers or special-purpose computers, such as a processor, a controller, an arithmetic logic unit (ALU), a digital signal processor, a microcomputer, a field programmable gate array (FPGA), a programmable logic unit (PLU), a microprocessor or any device which may execute instructions and respond. A processing unit may implement an operating system (OS) or one or more software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

The methods according to the above-described exemplary embodiments of the inventive concept may be implemented with program instructions which may be executed through various computer means and may be recorded in computer-readable media. The media may also include, alone or in combination with the program instructions, data files, data structures, and the like. The program instructions recorded in the media may be designed and configured specially for the exemplary embodiments of the inventive concept or be known and available to those skilled in computer software. Computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter. The described hardware devices may be configured to act as one or more software modules to perform the operations of the above-described exemplary embodiments of the inventive concept, or vice versa.

According to the embodiments of the inventive concept, a virtual self-control space may be created based on a location of the user regardless of place and time. The user may commonly perform a self-control activity (for example, locking of an app, interruption of an alarm, and may request for allowance of use of a group) by participating in an interested virtual self-control space, after searching for a virtual self-control space within a short distance. Accordingly, disturbance of group activities due to use of a personal smartphone may be minimized by commonly self-controlling use of the smartphones through participation in a virtual self-control space.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, the other implementation, the other embodiment, and those that are equivalent to the claims also fall within the scope of the inventive concept.

What is claimed is:

1. A method for mediating uses of smart devices of group users, the method comprising:
creating a location-based virtual self-control space;
searching for a virtual self-control space that is adjacent to a smart device of a requester for mediating uses of the smart devices of the group users, from the created virtual self-control space;
selecting an interest space which the requester is to participate in, from the found virtual self-control space, and allowing smart devices of group users pertaining to the interest space to participate in self-control of use;
allowing the smart devices of the group users to apply a use restraining mode in the virtual self-control space corresponding to the interest space; and
after applying the use restraining mode, allowing the smart devices of the group users to release the use restraining mode in the virtual self-control space corresponding to the interest space.

2. The method of claim 1, wherein the creating of the location-based virtual self-control space comprises:
collecting location information of the requester for medicating uses of the smart devices of the group users;
setting the virtual self-control space, based on the collected location information; and
registering the preset virtual self-control space in a database.

3. The method of claim 2, wherein the setting of the virtual self-control space is changed and the changed virtual self-control space is reregistered, and the setting of the virtual self-control space comprises space information and self-control restraining rules for respective self-control spaces.

4. The method of claim 3, wherein functions of the self-control restraining rules comprise a function of temporarily releasing a restraint.

5. The method of claim 1, wherein the searching for the virtual self-control space comprises:
collecting information of a location at which the requester is currently situated, and searching for the location information of the requester and a virtual self-control space that is situated within a preset range.

6. The method of claim 1, wherein the selecting of the interest space comprises:
collecting the location information of the requester, selecting an interest space, which the requester is to participate in, of the found virtual self-control space, and allowing the smart devices of the group users pertaining to the interest space to participate in a group self-control mode through participation in the virtual self-control space.

7. The method of claim 1, wherein the allowing of the smart devices of the group users to apply a use restraining mode in the virtual self-control space comprises:
at the same time when the use restraining mode starts, periodically recording a group situation of the smart devices of the group users and peripheral devices connected to the smart devices, and restricting a specific function of functions of the smart devices of the group users and the peripheral devices connected to the smart devices.

8. A system for mediating uses of smart devices of group users, the system comprising:
a virtual self-control space creating unit that creates a location-based virtual self-control space;
a virtual self-control space searching unit that searches for a virtual self-control space that is adjacent to a smart device of a requester for mediating uses of the smart devices of the group users, from the created virtual self-control space;
an execution unit that selects an interest space which the requester is to participate in, from the found virtual self-control space, and allows smart devices of group users pertaining to the interest space to participate in self-control of use; and
a control unit that allows the smart devices of the group users to apply or release a use restraining mode in the virtual self-control space corresponding to the interest space.

9. The system of claim 8, wherein the virtual self-control space creating unit collects location information of the requester for medicating uses of the smart devices of the group users, sets the virtual self-control space, based on the collected location information, and registers the preset virtual self-control space in a database.

10. The system of claim 8, wherein the virtual self-control space searching unit collects information of a location at which the requester is currently situated, and searches for the location information of the requester and a virtual self-control space that is situated within a preset range.

11. The system of claim 8, wherein the execution unit collects the location information of the requester, selects an interest space, which the requester is to participate in, of the found virtual self-control space, and allows the smart devices of the group users pertaining to the interest space to participate in a group self-control mode through participation in the virtual self-control space.

12. The system of claim 8, wherein, at the same time when the use restraining mode starts, the control unit periodically records a group situation of the smart devices of the group users, and restricts a specific function of functions of the smart devices of the group users.
